(19) United States
(12) Patent Application Publication
(10) Pub. No.: US 2018/0203532 A1
(43) Pub. Date: Jul. 19, 2018

(54) TOUCH POLARIZING ELEMENT, FLEXIBLE TOUCH DISPLAY DEVICE AND METHOD FOR MANUFACTURING THE FLEXIBLE TOUCH DISPLAY DEVICE

(71) Applicants: Interface Technology (ChengDu) Co., Ltd., Sichuan (CN); Interface Optoelectronics (ShenZhen) Co., Ltd., Shenzhen (CN); General Interface Solution Limited, Miaoli County (TW)

(72) Inventors: Chih-Peng CHANG, Guangdong (CN); Chun-Lin TSENG, Guangdong (CN); Ping-Yang CHEN, Guangdong (CN)

(21) Appl. No.: 15/485,210

(22) Filed: Apr. 11, 2017

(30) Foreign Application Priority Data
Jan. 16, 2017 (CN) 201710033885.9

(51) Int. Cl. G06F 3/041

(52) U.S. Cl. CPC G06F 3/041; G06F 2203/04111; G06F 2203/04103; G06F 2203/04102

(57) ABSTRACT

A flexible touch display device includes a flexible display unit and a touch polarizing element. The touch polarizing element includes a polarizing film, a first flexible light-transmissive film, a second flexible light-transmissive film, a first touch sensing layer and a flexible circuit board. The first flexible light-transmissive film and the second flexible light-transmissive film are formed on two opposite surfaces of the polarizing film, respectively. The flexible display unit is connected to the second flexible light-transmissive film. The first touch sensing layer is directly formed on the first flexible light-transmissive film. The flexible circuit board is disposed on the first flexible light-transmissive film, and electrically connected to the first touch sensing layer.

This application claims priority to China Application Serial Number 201710033885.9, filed Jan. 16, 2017, which is herein incorporated by reference.

### BACKGROUND

### Field of Disclosure

The present disclosure relates to a touch display device. More particularly, the present disclosure relates to a flexible touch display device, a touch polarizing element of the flexible touch display device, and a method for manufacturing the flexible touch display device.

### Description of Related Art

Recently, touch display devices having touch-sensing technology not only are widely applied in a variety of electronic devices, but are also increasingly improving the practical performance of these electronic devices. These electronic devices for example are notebook computers, tablet PCs, smart mobile phones, GPS devices or electronic-paper displays, and are developed towards a trend of thin and short in size.

A conventional touch display device includes a touch panel and a display module. Since touch electrodes of the conventional touch panel are formed on a rigid glass substrate, the flexibility ability of the touch panel is poor, thereby, increasing the possibilities of the conventional touch display device being cracked during stretching, or hindering the development of the conventional touch display device towards a flexible design.

### SUMMARY

An aspect of the disclosure to provide a touch polarizing element, a flexible touch display device and a method for manufacturing the flexible touch display device, which are not only able to increase the flexibility of the flexible touch display device, but also effectively decrease the overall thickness of the flexible touch display device.

According to one embodiment, the touch polarizing element includes a polarizing film, a first flexible light-transmissive film, a second flexible light-transmissive film, a first touch sensing layer and a flexible circuit board. The polarizing film is provided with a first surface and a second surface which is opposite to the first surface. The first flexible light-transmissive film is disposed on the first surface of the polarizing film. The second flexible light-transmissive film is disposed on the second surface of the polarizing film. The flexible display unit is connected to the second flexible light-transmissive film. The first touch sensing layer is directly formed on the first flexible light-transmissive film. The flexible circuit board is disposed on the first flexible light-transmissive film, and electrically connected to the first touch sensing layer.

In one or more embodiments of the present disclosure, the first touch sensing layer is disposed on one surface of the first flexible light-transmissive film facing towards the polarizing film.

In one or more embodiments of the present disclosure the first touch sensing layer is disposed on one surface of the first flexible light-transmissive film opposite to the polarizing film.

In one or more, embodiments of the present disclosure, the touch polarizing element further includes a second touch sensing layer. The second touch sensing layer is directly formed on one surface of the first flexible light-transmissive film opposite to the first touch sensing layer. The first touch sensing layer and the second touch sensing layer are electrically isolated by the first flexible light-transmissive film.

In one or more embodiments of the present disclosure, at least one of the first flexible light-transmissive film and the second flexible light-transmissive film includes one or more materials selected from a group consisting of polyimide (PI), polyethylene naphthalate (PEN), polyethylene terephthalate (PET) and Polycarbonate (PC).

According to one embodiment, the flexible touch display device includes a flexible display unit and the aforementioned touch polarizing element connected to the flexible display unit.

As mentioned above, by internalizing a touch panel into an upper polarizing plate of the flexible touch display device, the flexible touch display device not only increases the flexibility of the flexible touch display device, but also effectively decreases the overall thickness of the flexible touch display device so as to meet a present design trend of the flexible touch display device being thin and having a short size.

In one or more embodiments of the present diclosure, the flexible display unit is a flexible liquid crystal display unit, a flexible electrophoresis display unit, or an active-matrix organic light-emitting diode (AMOLED) display unit.

According to one embodiment, the method for manufacturing a flexible touch display device includes steps as follows. A first touch sensing layer is formed on a first flexible light-transmissive film. The first flexible light-transmissive film is attached on a polarizing film. A second flexible light-transmissive film is formed on one surface of the polarizing film opposite to the first flexible light-transmissive film. A flexible display unit is connected to the second flexible light-transmissive film.

In one or more embodiments of the present disclosure, the method further includes a step of bonding a flexible circuit board to the first flexible light-transmissive film, and electrically connecting to the first touch sensing layer after the first touch sensing layer is formed on the first flexible light-transmissive film.

In one or more embodiments of the present disclosure, the method further includes a step of forming a second touch sensing layer on one surface of the first flexible light-transmissive film opposite to the first touch sensing layer before the first flexible light-transmissive film is attached on the polarizing film, and the first touch sensing layer and the second touch sensing layer are electrically isolated by the first flexible light-transmissive film.

Therefore, since the touch sensing layer of the touch panel are designed to form on the first flexible light-transmissive film instead, the manufacturing process of the conventional touch panel can be effectively shortened so as to further reduce manufacturing cost and time of the flexible touch display device of the disclosure.

It is to be understood that both the foregoing general description and the following detailed description are by examples, and are intended to provide further explanation of the disclosure as claimed.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. In the drawings,

FIG. 1 is a schematic view of a flexible touch display device according to one embodiment of the disclosure;

FIG. 2 is a flow chart of a method for manufacturing the flexible touch display device according to one embodiment of the disclosure;

FIG. 3A-FIG. 3F are operational schematic views according to the method of FIG. 2;

FIG. 4 is a side view of a flexible touch display device according to one embodiment of the disclosure; and

FIG. 5 is a side view of a flexible touch display device according to one embodiment of the disclosure.

### DESCRIPTION OF THE EMBODIMENTS

Reference will now be made in detail to the present embodiments of the disclosure, examples of which are illustrated in the accompanying drawings. Wherever possible, the same reference numbers are used in the drawings and the description to refer to the same or like parts. According to the embodiments, it will be apparent to those skilled in the art that various modifications and variations can be made to the structure of the present disclosure without departing from the scope or spirit of the disclosure.

Since applicants has found that a polyvinyl alcohol (PVA) film is sandwiched between two layers of triacetyl cellulose (TAC) films in a conventional polarizer, and after the TAC films are attached to the PVA film, the TAC films will increase the brittleness of the conventional polarizer so as to greatly reduce the overall flexibility of the conventional polarizer, thus, overall flexibility of the conventional polarizer may be greatly reduced. Therefore, the applicants integrate a polarizing film into a touch display device, and replace the TAC films with a highly flexible material so that the flexibility of the polarizing film not only is dramatically increased, but also the overall thickness of the flexible touch display device is effectively decreased so as to meet a present design trend of the flexible touch display device being thin and having a short size.

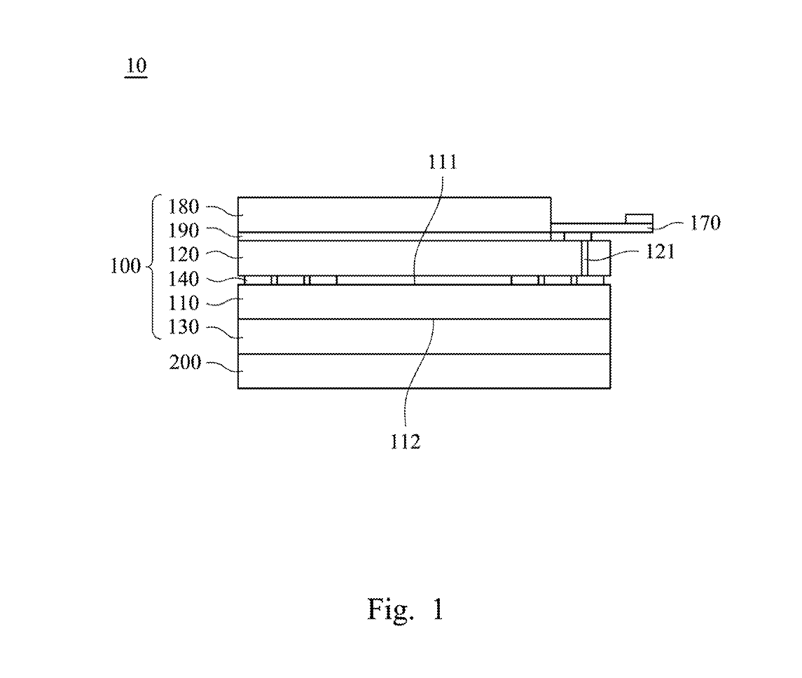

Reference is now made to FIG. 1, in which FIG. 1 is a schematic view of a flexible touch display device according to one embodiment of the disclosure. As shown in FIG. 1, in the embodiment, the flexible touch display device 10 includes a touch polarizing element 100 and a flexible display unit 200. The touch polarizing element 100 includes a polarizing film 110, a first flexible light-transmissive film 120, a second flexible light-transmissive film 130, a first touch sensing layer 140 and a flexible circuit board 170. The polarizing film 110 is formed with a first surface 111 and a second surface 112 which are arranged opposite to each other, and the polarizing film 110 converts transmitted incident lights from the flexible display unit 200 into linearly polarized lights. The first flexible light-transmissive film 120 is attached on the first surface 111 of the polarizing film 110 for protecting the first surface 111 of the polarizing film 110. The second flexible light-transmissive film 130 is disposed between the second surface 112 of the polarizing film 110 and the flexible display unit 200. The second flexible light-transmissive film 130 is attached on the second surface 112 of the polarizing film 110 for protecting the second surface 112 of the polarizing film 110. The first touch sensing layer 140 is directly formed on the first flexible light-transmissive film 120 for receiving touch signals from a user. The flexible circuit board 170 is disposed on the first flexible light-transmissive film 120 and electrically connected to the first touch sensing layer 140, and the flexible circuit board 170 is used for electrically conducting inner and external circuits of the flexible touch display device 10. However, the disclosure is not limited thereto.

Therefore, since a polarizing plate is internalized into a touch display device of the embodiment, the overall thickness of the flexible touch display device 10 can be effectively decreased, for example, down to 100 μm so as to meet a design trend towards thin and short in size at present.

In the embodiment, the first touch sensing layer 140 for example includes a sensing electrode pattern (not shown in figures) with sensing electrodes and line electrodes therein. Specifically, the first touch sensing layer 140 is disposed on one surface of the first flexible light-transmissive film 120 facing towards the polarizing film 110. However, the disclosure is not limited that the first touch sensing layer 140 is disposed on the first flexible light-transmissive film 120 only.

In addition, the touch polarizing element 100 in the embodiment further includes a protective transparent layer 180. The protective transparent layer 180 covers one side of the first flexible light transmissive film 120 opposite to the polarizing film 110 for protecting the first touch sensing layer 140. Furthermore, the protective transparent layer 180 can be a flexible cover lens, and the protective transparent layer 180 is affixed on one side of the first flexible light-transmissive film 120 opposite to the polarizing film 110 with an optically clear adhesive (OCA) layer 190.

It is noted, the polarizing film 110 in the embodiment is a polyvinyl alcohol (PVA) film. Precisely, the polarizing film 110 in the embodiment is a PVA film which absorbs a dichroic dye or an iodide and is formed with alignment property. For example, in this embodiment, the PVA film can be made by gelatinizing polyvinylacetate.

Also, the first flexible light-transmissive film 120 and the second flexible light-transmissive film 130 are the same in material, however, the disclose is not limited thereto. In the embodiment, the material of the first flexible light-transmissive film 120 and the second flexible light-transmissive film 130 is organic high molecular polymer. The organic high molecular polymer, for example, can be polyimide (PI), polyethylene naphthalate (PEN), polyethylene terephthalate (PET) or Polycarbonate(PC), however, the disclosure is not limited to the aforementioned types. It is noted, since the first flexible light-transmissive film 120 and the second flexible light-transmissive film 130 are not solidified resin layers, thus, it is not necessary to respectively cure the first flexible light-transmissive film 120 and the second flexible light-transmissive film 130 by an ultraviolet irradiation device.

In the embodiment the flexible properties (represented as ψ value) of the first flexible light-transmissive film 120 and the second flexible light-transmissive film 130 are lower than 5 microns (mm), and the times of flexing the first flexible light-transmissive film 120 and the second flexible light-transmissive film 130 are about 50,000 times. It is noted, the larger the iv value is, the higher the optical transmittance of those films is, and the smaller the surface resistance value is.

In addition, the flexible display unit 200 in the embodiment can be an active-matrix organic light-emitting diode (AMOLED) display unit, however, the disclosure is not limited thereto, in another embodiment, the flexible display unit 200 also can be a flexible liquid crystal display unit or a flexible electrophoresis display unit.

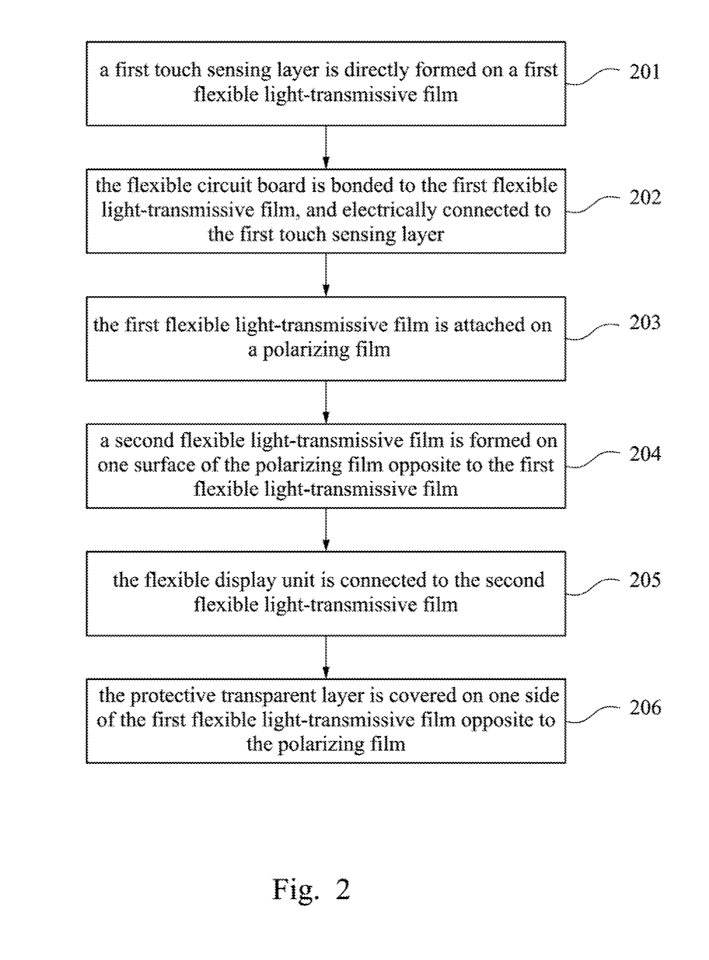

FIG. 2 is a flow chart of a method for manufacturing the flexible touch display device 10 according to one embodiment of the disclosure. As shown in FIG. 2, the method for manufacturing the flexible touch display device 10 includes step 201 to step 206 outlined as follows. In step 201, a first touch sensing layer 140 is directly formed on a first flexible light-transmissive film 120. In step 202, the flexible circuit board 170 is bonded to the first flexible light-transmissive film 120, and electrically connecting to the first touch sensing layer 140. In step 203, the first flexible light-transmissive film 120 is attached on a polarizing film 110. In step 204, a second flexible light-transmissive film 130 is formed on one surface of the polarizing film 110 opposite to the first flexible light-transmissive film 120. In step 205, the aforementioned flexible display unit 200 is connected to the second flexible light-transmissive film 130. In step 206 the aforementioned protective transparent layer 180 is covered on one side of the first flexible light-transmissive film 120 opposite to the polarizing film 110.

Therefore, since the touch sensing layer of the touch panel are designed to form on the first flexible light-transmissive film 120, the manufacturing process of the touch panel can be effectively shortened so as to further reduce manufacturing cost and time of the flexible touch display device of the disclosure.

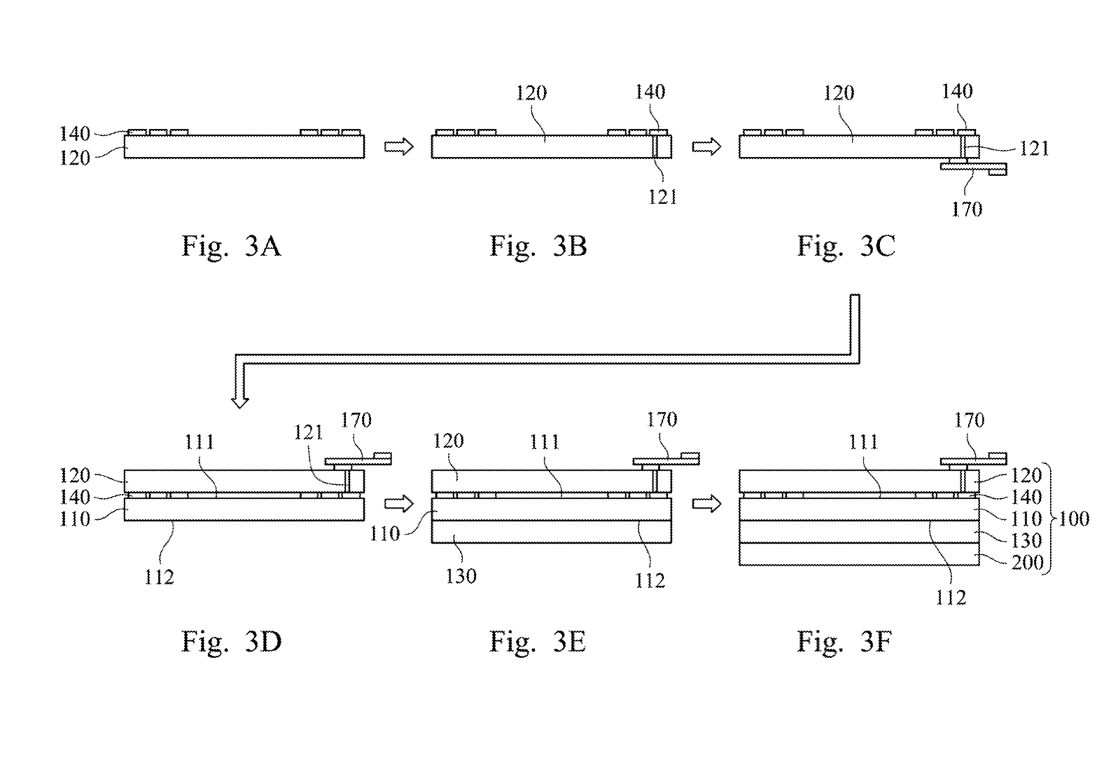

FIG. 3A-FIG. 3F are operational schematic views according to the method of FIG. 2. in the embodiment of step 201, more specifically, as shown in FIG. 2 and FIG. 3A, the first touch sensing layer 140 is made by indium tin oxide (ITO) processed through coating and patterning treatments to be directly formed on one surface of the first flexible light-transmissive film 120. However, the material type, the extending direction, the number of electrodes and the shape of the first inductive touch layer 140 can be adjusted in accordance with different requirements, and are not limited to a specific type. Besides, as shown in FIG. 3B, in this embodiment, the step 201 further includes a step of drilling the first inductive touch layer 140 with laser to form a via hole 121 thereon for electrically connecting the first inductive touch layer 140.

In this embodiment of the step 201, more specifically, as shown in FIG. 2 and FIG. 3C, the flexible circuit board 170 is connected to one surface of the first flexible light-transmissive film 120 opposite to the first inductive touch layer 140, and is electrically connected to the first inductive touch layer 140 through the via hole 121.

In this embodiment of the step 201, more specifically, as shown in FIG. 2 and FIG. 3D, firstly, the first flexible light-transmissive film 120 is vertically flipped to position the flexible circuit board 170 above the first flexible light-transmissive film 120; next, the first flexible light-transmissive film 120 is affixed on the first surface 111 of the polarizing film 110. The first flexible light-transmissive film 120 for example, is affixed on the first surface 111 of the polarizing film 110 with an optically clear adhesive (not shown in figures).

In this embodiment of the step 204, more specifically, as shown in FIG. 2 and FIG. 3E, the second flexible light-transmissive film 130 is not limited to directly form on the second surface 112 of the polarizing film 110, or affixed on the second surface 112 of the polarizing film 110 with an optically clear adhesive (not shown in figures) so that the polarizing film 110 is sandwiched between the first flexible light-transmissive film 120 and the second flexible light-transmissive film 130, thereby, the aforementioned touch polarizing element 100 is formed. At this moment, since the first inductive touch layer 140 is sandwiched between the polarizing film 110 and the first flexible light-transmissive film 120, the first inductive touch layer 140 is protected by the first flexible light-transmissive film 120 and the second flexible light-transmissive film 130 as well.

In this embodiment of the step 205, more specifically, as shown in FIG. 2 and FIG. 3F, the flexible display unit 200 is affixed on the second flexible light-transmissive film 130 of the aforementioned touch polarizing element 100 with an optically clear adhesive (not shown in figures). However, in another embodiment, the touch polarizing element further includes a release film and an optically clear adhesive. The optically clear adhesive is formed between the release film and the second flexible light-transmissive film, thus, after the release film is peeled off, the touch polarizing element can be affixed on the flexible display unit with the optically clear adhesive.

In this embodiment of the step 206, more specifically, as shown in FIG. 1 and FIG. 2, the protective transparent layer 180 is affixed on one surface of the aforementioned touch polarizing element 100 opposite to the flexible display unit 200 with the optically clear adhesive layer 190.

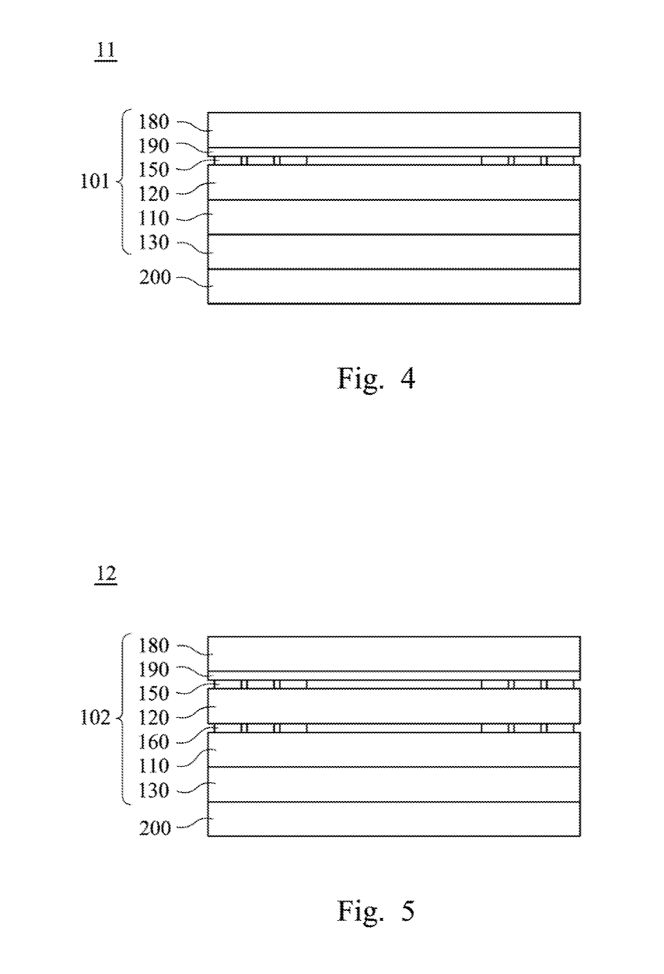

FIG. 4 is a side view of a flexible touch display device 11 according to one embodiment of the disclosure. As shown in FIG. 4, the structure and the manufacturing method of the flexible touch display device 11 of FIG. 4 is substantially the same to those of the flexible touch display device 10 of FIG. 1, except that the first touch sensing layer 150 of the touch polarizing element 101 in FIG. 4 is disposed on one surface of the first flexible light-transmissive film 120 opposite to the polarizing film 110, rather than one surface of the first flexible light-transmissive film 120 facing to the polarizing film 110. Thus, comparing to the first touch sensing layer 140 of FIG. 1, since the first touch sensing layer 150 of FIG. 4 is closer to the protective transparent layer 180, the touch sensitivity accuracy of the flexible touch display device 11 touched by user can be effectively improved.

FIG. 5 is a side view of a flexible touch display device 12 according to one embodiment of the disclosure. As shown in FIG. 5, the structure and the manufacturing method of the flexible touch display device 12 of FIG. 5 is substantially the same to those of the flexible touch display device 10 of FIG. 1, except that since the touch polarizing elements 100 of FIG. 1 and the touch polarizing elements 101 of FIG. 4 respectively are single-layer wiring structure (e.g., single-layer ITO, SITO), the touch polarizing element is provided with the first touch, sensing layer 140, 150 on single side of the first flexible light-transmissive film 120, and electrodes of first touch sensing layer 140, 150 can be connected with one another with conductive bridge structure if necessary. However, the touch polarizing elements 102 of FIG. 5 is a double-layer wiring structure (e.g., single-layer ITO, DITO). The touch polarizing elements 102 further includes a second touch sensing layer 160. The second touch sensing layer 160 is directly formed on one surface of the first flexible light-transmissive film 120 opposite to the first touch sensing layer 150, and the first touch sensing layer 150 and the second touch sensing layer 160 are electrically isolated by the first flexible light-transmissive film 120.

In addition, it is noted that for providing touch sensing layers on two opposite sides of the first flexible light-transmissive film 120, while the flexible touch display device 12 shown in FIG. 5 is manufactured, before the first flexible light-transmissive film 120 is affixed on the polarizing film 110 (i.e., step 203 of FIG. 2), a second touch sensing layer 160 can be directly formed on one surface of the first flexible light-transmissive film 120 opposite to the first touch sensing layer 150, and electrically connected to t he flexible circuit board 170 within the step of directly forming the first touch sensing layer 150 on the first flexible light-transmissive film 120 (i.e., step 201 as shown in FIG. 2).

Although the present disclosure has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fa within the scope of the following claims and their equivalents.

What is claimed is:

1. A touch polarizing element, comprising:
a polarizing film having a first surface and a second surface which is opposite to the first surface;
a first flexible light-transmissive film disposed on the first surface of the polarizing film;
a second flexible light-transmissive film disposed on the second surface of the polarizing film;
a first touch sensing layer directly formed on the first flexible light-transmissive film; and
a flexible circuit board disposed on the first flexible light-transmissive film, and electrically connected to the first touch sensing layer.

2. The touch polarizing element of claim 1, wherein the first touch sensing layer is disposed on one surface of the first flexible light-transmissive film facing towards the polarizing film.

3. The touch polarizing element of claim 1, wherein the first touch sensing layer is disposed on one surface of the first flexible light-transmissive film opposite to the polarizing film.

4. The touch polarizing element of claim 1, further comprising:
a second touch sensing layer directly formed on one surface of the first flexible light-transmissive film opposite to the first touch sensing layer, wherein the first touch sensing layer and the second touch sensing layer are electrically isolated by the first flexible light-transmissive film.

5. The touch polarizing element of claim 1, wherein at least one of the first flexible light-transmissive film and the second flexible light-transmissive film comprises one or more materials selected from a group consisting of polyimide (PI), polyethylene naphthalate (PEN), polyethylene terephthalate (PET) and Polycarbonate(PC).

6. A flexible touch display device, comprising:
a flexible display unit; and
a touch polarizing element of claim 1 connected to the flexible display unit.

7. The flexible touch display device of claim 6, wherein the flexible display unit is a flexible liquid crystal display unit, a flexible electrophoresis display unit, or an active-matrix organic light-emitting diode (AMOLED) display unit.

8. A method for manufacturing a flexible touch display device, comprising:
forming a first touch sensing layer on a first flexible light-transmissive film;
attaching the first flexible light-transmissive film on a polarizing film;
forming a second flexible light-transmissive film on one surface of the polarizing film opposite to the first flexible light-transmissive film; and
connecting a flexible display unit to the second flexible light-transmissive film.

9. The method of claim 8, further comprising:
bonding a flexible circuit board to the first flexible light-transmissive film, and electrically connecting to the first touch sensing layer after the first touch sensing layer is formed on the first flexible light-transmissive film.

10. The method of claim 8, further comprising:
forming a second touch sensing layer on one surface of the first flexible light-transmissive film opposite to the first touch sensing layer before the first flexible light-transmissive film is attached on the polarizing film, wherein the first touch sensing layer and the second touch sensing layer are electrically isolated by the first flexible light-transmissive film.
